(19) United States
(12) Patent Application Publication
(10) Pub. No.: US 2008/0288255 A1
(43) Pub. Date: Nov. 20, 2008

(54) System and method for quantifying, representing, and identifying similarities in data streams

(76) Inventors: Lawrence Carin, Durham, NC (US); John Paisely, Durham, NC (US); Yuting Qi, Durham, NC (US); Xuejun Liao, Durham, NC (US); Qiuhua Liu, Durham, NC (US)

Correspondence Address: WILEY REIN LLP, 1776 K. STREET N.W., WASHINGTON, DC, 20006, US

(21) Appl. No.: 12/153,370

(22) Filed: May 16, 2008

Related U.S. Application Data
(60) Provisional application No. 60/924,468, filed on May 16, 2007.
(60) Provisional application No. 60/955,121, filed on Aug. 10, 2007.

(51) Int. Cl. G10L 15/14

(52) U.S. Cl. 704/256.1; 704/E15.001

(57) ABSTRACT

A method of quantifying similarities between sequential data streams typically includes providing a pair of sequential data streams, designing a Hidden Markov Model (HMM) of at least a portion of each stream; and computing a quantitative measure of similarity between the streams using the HMMs. For a plurality of sequential data streams, a matrix of quantitative measures of similarity may be created. A spectral analysis may be performed on the matrix of quantitative measure of similarity matrix to define a multi-dimensional diffusion space, and the plurality of sequential data streams may be graphically represented and/or sorted according to the similarities therebetween. In addition, semi-supervised and active learning algorithms may be utilized to learn a user's preferences for data streams and recommend additional data streams that are similar to those preferred by the user. Multi-task learning algorithms may also be applied.

### CROSS-REFERENCE TO RELATED APPLICATIONS

This application claims the benefit of U.S. provisional application No. 60/924,468, filed 16 May 2007, and U.S. provisional application No. 60/955,121, filed 10 Aug. 2007, which are hereby incorporated by reference as though fully set forth herein.

### BACKGROUND OF THE INVENTION

a. Field of the Invention

The instant invention relates to identifying similar data streams. In particular, the instant invention relates to a system and method for quantifying and representing similarities between data streams, as well as to rating and classifying data streams according to their similarities.

b. Background Art

With the burgeoning popularity of digital and online music, a great quantity and variety of music has become highly accessible, spanning a wide range of eras and musical genres and including both popular and lesser-known artists. However, this wealth of available music poses challenges for listeners and researchers alike. First, there is the challenge of how best to organize an audio library, which may contain thousands of songs and other audio tracks. Second, there is the challenge of how a listener can efficiently and effectively find new music the listener might like from within a vast library of perhaps thousands of songs and other audio tracks, potentially containing new and/or unfamiliar artists or songs.

Statistical models may be used to analyze music and to recognize similarities and relationships between different musical pieces. For example, in the work of Logan and Salomon (B. Logan and A. Salomon, “A music similarity function based on signal analysis.” in ICME 2001, 2001), which is hereby incorporated by reference as though fully set forth herein, the sampled music signal is divided into overlapping frames and Mel-frequency cepstral coefficients (MFCCs) are computed as a feature vector for each frame. A K-means method is then applied to cluster frames in the MFCC feature space. In the work of Aucouturier and Pachet (J.-J. Aucouturier and F. Pachet, “Improving timbre similarity: How high's the sky?” Journal of Negative Results in Speech and Audio Sciences, vol. 1, no. 1, 2004), which is hereby incorporated by reference as though fully set forth herein, the distribution of the MFCCs over all frames of an individual song is modeled using a Gaussian mixture model (GMM), and the distance between two pieces is evaluated based on their respective GMMs. However, the aforementioned systems and methods do not account for the dynamic—that is, time—evolving-behavior of the songs being modeled. This is a shortcoming because, in recognition and appreciation of music by the human brain, temporal cues contain beneficial and exploitable information.

In addition, as audio libraries expand, the likelihood that there are new and/or unfamiliar artists and/or tracks in the library increases, potentially making it more difficult for a listener to locate tracks of interest. The proliferation of independent artists (e.g., artists not associated with a major record label) desiring exposure (or “discovery”) may compound this difficulty. Though some extant systems attempt to suggest tracks that a particular user may find interesting, they typically do not do so on the basis of that particular user's individualized or personalized tastes, for example relying instead on music purchased, downloaded, suggested, or listened to by other users or metadata associated with tracks (e.g., suggesting new songs by the same artist as the listener has purchased in the past).

### BRIEF SUMMARY OF THE INVENTION

It is therefore desirable to compute a quantitative measure of similarity between sequential data streams, such as audio streams, that accounts for the time-evolving properties of the data streams.

It is also desirable to provide a quantitative measure of similarity between sequential data streams, such as audio streams, that may be used to rank-order the similarity of music in a digital music library.

Further, it is desirable to provide a quantitative measure of similarity between sequential data streams, such as audio streams, that may be used to graphically represent the sequential data streams in a multi-dimensional diffusion space.

It is still another object of the present invention to provide a quantitative measure of similarity between sequential data streams, such as audio streams, that may be used to identify sequential data streams that are most similar to those preferred by a particular individual, and thus that are most likely to be preferred by the same individual.

Yet another object of the present invention is to provide a system and method for providing data stream recommendations that are personalized to an individual user's tastes.

In some embodiments of the invention, the present invention provides a method of managing a plurality of data streams, including the steps of: obtaining a plurality of data streams; analyzing each of the plurality of data streams based on similarities in content (e.g., by using a Hidden Markov Model for each of the plurality of data streams); defining an n-dimensional mapping space, wherein “n” is based on the number of streams in the plurality of data streams; and using the analysis of content similarities to map each of the plurality of data streams into the n-dimensional mapping space based on similarities. For example, the plurality of data streams may be displayed on a graphical representation of at least two dimensions of the n-dimensional mapping space. Thereafter, one of the plurality of data streams may be selected to serve as a query selection. A distance threshold may be defined, and one or more of the plurality of data streams that are within the distance threshold of the query selection, as measured within the n-dimensional mapping space, may be identified.

The present invention may also be practiced to identify preferred data streams by following the steps of: presenting a first plurality of data streams; rating each of the first plurality of data streams with a plurality of rating levels; obtaining a second plurality of data streams; analyzing each of the first plurality of data streams and the second plurality of data streams based on similarities in content (e.g., by using a Hidden Markov Model for each of the plurality of data streams); using the analysis of content similarities to map each of the first plurality of data streams and the second plurality of data streams into an n-dimensional mapping space based on similarities; defining a probability threshold; defining a rating threshold; and identifying at least one data stream from the second plurality of data streams that has a calculated probability greater than the probability threshold that the identified data stream would be assigned a rating level that is greater than the rating threshold.

Further disclosed herein is a method of quantifying similarities between sequential data streams, such as audio streams. In the context of audio streams, the method includes the following steps: providing a first audio stream; providing a second audio stream; designing a first Hidden Markov Model of at least a portion of the first audio stream; designing a second Hidden Markov Model of at least a portion of the second audio stream; and computing a quantitative measure of similarity between the first audio stream and the second audio stream using the first Hidden Markov Model and the second Hidden Markov Model. In some embodiments of the invention, the first audio stream and the second audio stream are, respectively, a first musical recording and a second musical recording. Typically, the Hidden Markov Models for the first and second audio streams will be designed by identifying a plurality of Mel Frequency Cepstral Coefficients features of at least a portion of the audio stream and designing a Hidden Markov Model of the identified plurality of Mel Frequency Cepstral Coefficients.

Preferably, at least one of, and more preferably both of (a) a number of Hidden Markov Model states in the first Hidden Markov Model and (b) a number of Hidden Markov Model states in the second Hidden Markov Model is determined non-parametrically. This may be accomplished, for example, by using a variational Bayes inference algorithm, such as a variational Bayes inference algorithm based upon a Dirichlet process.

It is contemplated that the step of computing a quantitative measure of similarity between the first audio stream and the second audio stream using the first Hidden Markov Model and the second Hidden Markov Model includes synthesizing data using the first Hidden Markov Model (e.g., synthesizing a plurality of Mel Frequency Cepstral Coefficients features) and determining a probability that the data synthesized by the first Hidden Markov Model would have been synthesized by the second Hidden Markov Model. It may also include synthesizing data using the second Hidden Markov Model (e.g., synthesizing a plurality of Mel Frequency Cepstral Coefficients) and determining a probability that the data synthesized by the second Hidden Markov Model would have been synthesized by the first Hidden Markov Model. The probabilities so determined may be averaged in computing the quantitative measure of similarity between the first audio stream and the second audio stream.

Of course, it is within the spirit and scope of the invention to practice the method of quantifying similarities between sequential data streams on other sequential data streams, including, but not limited to, streams of financial data and streams of genetic data.

Also disclosed herein is a method of representing similarities between a plurality of sequential data streams, such as audio streams. In the context of audio streams, the method includes the steps of: (a) selecting an audio stream i from the plurality of audio streams; (b) designing a Hidden Markov Model of at least a portion of the audio stream i; (c) selecting an audio stream j from the plurality of audio streams; (d) designing a Hidden Markov Model of at least a portion of the audio stream j; (e) computing a quantitative measure of similarity dᵢⱼ between the audio stream i and the audio stream j using the Hidden Markov Model of the at least a portion of the audio stream i and the Hidden Markov Model of the at least a portion of the audio stream j; and (f) repeating steps (c), (d), and (e) for each audio stream j in the plurality of audio streams, thereby computing a vector of quantitative measures of similarity for the audio stream i. The vector may be expressed in terms of a random walk (e.g., conditional probabilities) between audio streams. Optionally, steps (a), (b), (c), (d), (e), and (f) may be repeated for each audio stream i in the plurality of audio streams, thereby computing a matrix of quantitative measures of similarity. The method may also include calculating a confidence value cᵢⱼ for audio streams i and j, wherein the confidence value is calculated as a ratio of the quantitative measure of similarity between audio streams i and j to a maximum dᵢⱼ in the matrix of quantitative measures of similarity.

In some embodiments of the invention, the matrix of quantitative measures of similarity is normalized into a probability matrix of probabilities p(j|i). An Eigen analysis may be performed on the probability matrix, thereby defining a multi-dimensional eigenspace. In addition, at least some of the plurality of audio streams may be displayed in (e.g., plotted on a graphical representation of) at least two dimensions of the multi-dimensional eigenspace. Preferably, at least some of the plurality of audio streams will be displayed in (e.g., plotted on a graphical representation of) at least three dimensions of the multi-dimensional eigenspace.

It is also contemplated that audio streams may be rank-sorted according to similarity. Thus, the method may also include selecting an audio stream from the plurality of audio streams and sorting at least a subset of the plurality of audio streams according to Euclidean distances between each of the subset of the plurality of audio streams and the selected audio stream, wherein the Euclidean distances are calculated in the multi-dimensional eigenspace. Alternatively, two or more of the audio streams j may be sorted according to quantitative measures of similarity dᵢⱼ between each of the two or more audio streams j and the audio stream i.

Of course, the method of representing similarities between sequential data streams may also be practiced in connection with other types of sequential data streams, including, but not limited to, financial data streams and genetic data streams.

In addition, it is within the spirit and scope of the present invention to represent similarities between data streams generally (e.g., both sequential and non-sequential data streams) according to the following steps: (a) selecting a pair of data streams i and j from a plurality of data streams; (b) computing a quantitative measure of similarity dᵢⱼ between the pair of data streams i and j; (c) repeating steps (a) and (b) for each pair of data streams i and j in the plurality of data streams, thereby computing a matrix of quantitative measures of similarity for the plurality of data streams; (d) normalizing the matrix of quantitative measures of similarity into a probability matrix of probabilities p (j|i); and (e) performing an Eigen analysis on the probability matrix, thereby defining a multi-dimensional eigenspace. At least some of the plurality of data streams may be plotted in a graphical representation of at least two dimensions of the multi-dimensional eigenspace. Alternatively, or in addition, a data stream may be selected from the plurality of data streams, and two or more unselected data streams may be sorted according to distances between the two or more unselected data streams and the selected data stream, wherein the distances are calculated in the multi-dimensional eigenspace.

In another aspect of the invention, a system for quantifying and representing similarities between sequential data streams includes: a modeling processor configured to design a first Hidden Markov Model of at least a portion of a first member of a pair of sequential data streams and a second Hidden Markov Model of at least a portion of a second member of a pair of sequential data streams; and a comparison processor configured to compute a quantitative measure of similarity between the first and second members of the pair of sequential data streams using the first Hidden Markov Model and the second Hidden Markov Model. The system may optionally include a storage medium configured to store a plurality of sequential data streams and a vector composition processor configured to compose a vector of quantitative measures of similarity for a sequential data stream selected from the plurality of sequential data streams, the vector being composed of quantitative measures of similarity computed by the comparison processor between the selected sequential data stream and each unselected sequential data stream. The system may also include a matrix composition processor configured to compose a matrix of quantitative measures of similarity for the plurality of sequential data streams, the matrix being composed of vectors of quantitative measures of similarity computed by the vector composition processor for each sequential data stream and/or an Eigen analysis processor configured to perform an Eigen analysis on the matrix of quantitative measures of similarity, thereby defining a multi-dimensional eigenspace. In addition, in some embodiments of the invention, the system also includes a sorting processor configured to sort two or more of the plurality of sequential data streams according to distances between each of the two or more of the plurality of sequential data streams and a sequential data stream of interest, the distances being calculated in the multi-dimensional eigenspace. Alternatively, or in addition, the sorting processor may be configured to sort two or more of the plurality of sequential data streams according to quantitative measures of similarity between each of the two or more of the plurality of audio streams and the selected sequential data stream.

A suitable output device, optionally including controls configured to manipulate a graphical representation, and a plotting processor configured to output a graphical representation of at least some of the plurality of sequential data streams in at least two dimensions of the multi-dimensional eigenspace to the output device may also be provided.

Also disclosed herein is a system for quantifying and representing similarities between audio streams. The system includes: a plurality of audio streams; a modeling processor configured to design a Hidden Markov Model of at least a portion of each audio stream in the plurality of audio streams; a conditional probability processor configured to compose a normalized matrix of quantitative measures of similarity for the plurality of audio streams using the Hidden Markov Models designed by the modeling processor; a spectral analysis processor configured to perform an Eigen analysis on the normalized matrix of quantitative measures of similarity, thereby defining a multi-dimensional eigenspace; an interface configured to accept search criteria; a search processor configured to search the plurality of audio streams using the search criteria and retrieve one or more matching audio streams; an output device configured to output the one or more matching audio streams; an interface configured to accept selection of one of the one or more matching audio streams; a sorting processor configured to sort one or more of the plurality of audio streams according to their similarity to the selected one of the one or more matching audio streams; and an output device configured to output the sorted one or more of the plurality of audio streams.

In still another aspect of the present invention, a computer system for modeling similarities within a plurality of audio streams, includes: a storage medium configured to store a plurality of audio streams to be modeled; a modeling processor configured to design a Hidden Markov Model of at least a portion of each audio stream to be modeled; a comparison processor configured to calculate quantitative measures of similarity between pairs of audio streams to be modeled; a matrix composition processor configured to compose a normalized probability matrix for the plurality of audio streams to be modeled from the quantitative measures of similarity output by the comparison processor; a spectral analysis processor configured to perform an Eigen analysis on the normalized probability matrix, thereby defining a multi-dimensional diffusion space; and a graphical user interface including a display window configured to display a graphical representation of the plurality of audio streams to be modeled in at least two dimensions of the multi-dimensional diffusion space. The graphical user interface may include an input panel including controls configured to manipulate the graphical representation of the plurality of audio streams to be modeled.

In yet another aspect of the present invention, a method of rating data streams, such as audio streams, includes the steps of: providing a plurality of audio streams; associating a rating with each of a subset of the plurality of audio streams, wherein the rating is selected from a plurality of ratings; calculating a quantitative measure of similarity vector for each audio stream in the subset of the plurality of audio streams; computing a logistic link parameter vector for the plurality of audio streams based on the calculated quantitative measure of similarity vectors; selecting an unrated audio stream not included in the subset of the plurality of audio streams; choosing a rating from the plurality of ratings; and calculating a probability that the selected unrated audio stream has the chosen rating based on the logistic link parameter vector.

The step of calculating a quantitative measure of similarity vector for each audio stream in the subset of the plurality of audio streams may include calculating a normalized quantitative measure of similarity vector for each audio stream in the subset of the plurality of audio streams. In some embodiments of the invention, the step of calculating a quantitative measure of similarity vector for each audio stream in the subset of the plurality of audio streams is carried out using a Hidden Markov Model for each audio stream in the plurality of audio streams.

The plurality of ratings may include two discrete ratings (e.g., like and dislike), any other number of discrete ratings (e.g., a scale of 1-100), or a continuous “sliding scale.” Ratings may, for example, be indicative of a level of interest in the audio stream.

It is contemplated that each of the plurality of audio streams may be expressed as a Mel frequency cepstral coefficients feature vector, such that the step of computing a logistic link parameter vector for the plurality of audio streams may involve computing the logistic link parameter vector for the plurality of audio streams based on the Mel frequency cepstral coefficients feature vectors for each of the plurality of audio streams.

The step of computing a logistic link parameter vector for the plurality of audio streams may include computing the logistic link parameter vector using a maximum likelihood algorithm, such as an expectation-maximization algorithm.

In some embodiments of the invention, an active learning algorithm is employed to define the subset of the plurality of audio streams to minimize uncertainty in computation of the logistic link parameter vector. Uncertainty in the logistic link parameter vector may be measured in terms of Shannon entropy. Accordingly, it is contemplated that the step of associating a rating with each of a subset of the plurality of audio streams may include: selecting an audio stream to rate from the plurality of audio streams; assigning a rating from the plurality of ratings to the selected audio stream; and adding the selected audio stream and assigned rating to the subset of the plurality of audio streams. In turn, it is contemplated that the step of selecting an audio stream to rate from the plurality of audio streams may include selecting an audio stream that will provide a largest expected reduction in Shannon entropy in the logistic link parameter vector when rated. Alternatively, the audio stream selected may be one that is expected to reduce the Shannon entropy by at least a preset amount. Of course, the steps of selecting an audio stream to rate from the plurality of audio streams, assigning a rating from the plurality of ratings to the selected audio stream, and adding the selected audio stream and assigned rating to the subset of the plurality of audio streams may be repeated until the largest expected reduction in Shannon entropy in the logistic link parameter vector is below a preset threshold value or until a user terminates the active learning process.

In some embodiments, the method includes calculating an expected rating for the selected unrated audio stream, for example by repeating the steps of choosing a rating from the plurality of classification values and calculating a probability that the selected unrated audio stream has the chosen rating for each rating in the plurality of ratings.

The present invention also includes a method of rating data streams, including the following steps: providing a plurality of data streams including a plurality of rated data streams and a plurality of unrated data streams, wherein each of the plurality of rated data streams is associated with a rating selected from a plurality of ratings; calculating a quantitative measure of similarity vector for each rated data stream; computing a logistic link parameter vector for the plurality of data streams based on the calculated quantitative measure of similarity vectors; selecting an unrated data stream; choosing at least one rating from the plurality of ratings; and calculating at least one probability that the selected unrated data stream has the chosen at one rating based on the logistic link parameter vector. The data streams may be sequential, such as audio streams (e.g., musical or spoken-word recordings), financial data streams, or genetic data streams, non-sequential (e.g., food or wine chemical spectra), and may be analog or digital. The plurality of rated data streams may include at least three rated data streams, and may be defined using an active-learning algorithm. The active-learning algorithm may include the steps of: (a) identifying a data stream from the plurality of data streams that will provide a largest expected reduction in uncertainty in the logistic link parameter vector when rated; (b) associating the identified data stream with a rating selected from the plurality of ratings; and (c) repeating steps (a) and (b) until the largest expected reduction in uncertainty in the logistic link parameter vector falls below a preset threshold value. The preset threshold value may be user-selectable.

Each of the plurality of data streams may have an associated feature vector, and the step of computing a logistic link parameter vector for the plurality of data streams may include computing the logistic link parameter vector for the plurality of data streams based on the feature vectors for the plurality of data streams.

In a further aspect of the invention, a method of recommending a data stream potentially of interest is provided according to a semi-supervised learning algorithm. The method includes: providing a plurality of data streams including a plurality of rated data streams and a plurality of unrated data streams, each of the plurality of rated data streams being associated with a rating level chosen from a plurality of rating levels; calculating a quantitative measure of similarity vector for each rated data stream; computing a logistic link parameter vector for the plurality of data streams based on the calculated quantitative measure of similarity vectors; and identifying one or more unrated data streams based on the logistic link parameter vector for the plurality of data streams. The step of identifying one or more unrated data streams based on the logistic link parameter vector may include the steps of: identifying a rating level threshold or criterion; identifying a probability threshold or criterion; using the logistic link parameter vector to identify one or more unrated data streams, wherein each of the identified one or more unrated data streams has a probability of being associated with a rating level greater than or equal to the rating level threshold that is greater than or equal to the probability threshold (e.g., identifying one or more unrated data streams meeting both the rating level criterion and the probability criterion). Of course, either or both of the rating level threshold and the probability threshold may be user-selectable, for example in order to define various queries for searching the plurality of data streams.

The semi-supervised learning algorithm described above may be used to recommend an audio stream to a user according to the following steps: providing a plurality of audio streams including a plurality of user-rated audio streams and a plurality of unrated audio streams; calculating a quantitative measure of similarity vector for each user-rated audio stream; computing a logistic link parameter vector for the plurality of audio streams based on the calculated quantitative measure of similarity vectors; and recommending at least one audio stream to the user based on the logistic link parameter vector for the plurality of audio streams. An active learning algorithm is optionally used in conjunction with the semi-supervised learning algorithm to, for example to minimize uncertainty in computation of the logistic link parameter vector in an effort to further tailor the recommendations to a user's preferences.

A system for recommending data streams according to the present invention includes: a plurality of data streams including a plurality of user-rated data streams and a plurality of unrated data streams; a comparison processor configured to compose a quantitative measure of similarity vector for each user-rated data stream in the plurality of user-rated data streams; a logistic link processor configured to compute a logistic link parameter vector for the plurality of data streams from the quantitative measure of similarity vectors; and a semi-supervised learning processor configured to identify at least one unrated data stream potentially of interest to a user based on the logistic link parameter vector. The system may also include: an interface configured to accept a rating criterion input; and an interface configured to accept a probability criterion input, wherein the semi-supervised learning processor identifies at least one unrated data stream meeting both the rating criterion and the probability criterion.

A system for recommending audio streams to a user according to the present invention includes: a database of audio streams; an interface configured to accept user input rating a plurality of audio streams in the database of audio streams; an interface configured to accept user input of a rating criterion; an interface configured to accept user input of a probability criterion; a comparison processor configured to compose a quantitative measure of similarity vector for each rated audio stream; a logistic link parameter vector configured to calculate a logistic link parameter vector for the database of audio streams using the quantitative measure of similarity vectors; a semi-supervised learning processor configured to identify at least one unrated audio stream meeting both the rating criterion and the probability criterion using the logistic link parameter vector; and an output device configured to output the identified at least one unrated audio stream. The interface configured to accept user input rating a plurality of audio streams may include: a sampling processor configured to select a coarse sample of the database of audio streams; an interface configured to accept a user rating for each audio stream in the coarse sample of the database of audio streams; an active learning processor configured to select one or more additional audio streams from the database of audio streams, wherein the selected one or more additional audio streams has a highest marginal expected reduction in uncertainty in computation of the logistic link parameter vector; and an interface configured to accept a user rating for each of the selected one or more audio streams.

Also disclosed herein is a method of searching a plurality of data streams, for example in the context of a marketplace for audio streams (e.g., music and spoken-word recordings). The method includes the steps of: selecting one or more data streams from a plurality of data streams; defining a quantitative measure of similarity vector for each of the selected one or more data streams; defining a quantitative measure of similarity search criterion; and using the quantitative measure of similarity vector to identify one or more unselected data streams from the plurality of data streams that meet the defined quantitative measure of similarity criterion. The quantitative measure of similarity search criterion may be a lower bound, an upper bound, a range, or any other suitable search criterion. The step of defining a quantitative measure of similarity vector for each of the selected one or more data streams typically includes: designing a Hidden Markov Model of at least a portion of each of the plurality of data streams; using the designed Hidden Markov Models to compute a plurality of quantitative measures of similarity between the selected one or more data streams and each unselected data stream; and composing a vector of the plurality of quantitative measures of similarity computed for each of the selected one or more data streams. In some embodiments of the invention, the step of using the quantitative measure of similarity vector to identify one or more unselected data streams includes generating a list of audio streams meeting the quantitative measure of similarity search criterion (e.g., a list of audio streams suggested for purchase, download, and/or playback).

Another aspect of the present invention is a system for searching a plurality of data streams, such as audio streams, including: a selection interface configured to present plurality of data streams and accept selection of one or more data streams thereof; a vector composition processor configured to define a quantitative measure of similarity vector for each of the selected one or more data streams; a search interface configured to define a quantitative measure of similarity search criterion; and a search processor configured to identify one or more unselected data streams meeting the defined quantitative measure of similarity criterion using the quantitative measure of similarity vector for each of the selected one or more data streams. The vector composition processor may include: a modeling processor configured to design a Hidden Markov Model of at least a portion of each of the plurality of data streams; a similarity processor configured to use the designed Hidden Markov Models to compute a plurality of quantitative measures of similarity between the selected one or more data streams and each unselected data stream; and a composition processor configured to compose a vector of the plurality of quantitative measures of similarity computed for each of the selected one or more data streams. An output device configured to present a list of the identified one or more unselected data streams meeting the defined quantitative measure of similarity criterion may also be provided.

In addition, in some embodiments, the present invention provides a method of providing product recommendations to a user. For example, the present invention may utilize a semi-supervised learning algorithm to recommend audio streams for purchase to a user. The method includes the following steps: providing a plurality of products, wherein each of the plurality of products is associated with a feature vector (e.g., a product-representative data stream); defining a quantitative measure of similarity matrix for the plurality of feature vectors; associating a rating with each of a subset of the plurality of feature vectors; defining a rating level criterion; defining a probability criterion; and using a semi-supervised learning algorithm to identify one or more unrated feature vectors meeting both the probability level criterion and the rating level criterion. It is contemplated that the step of associating a rating with each of a subset of the plurality of feature vectors may include applying an active learning algorithm to the plurality of feature vectors to “home in” on the user's preferences.

Still another embodiment of the present invention is a system for providing product recommendations to a user, including: a storage medium configured to store a plurality of feature vectors (e.g., product-representative data streams); a matrix composition processor configured to define a quantitative measure of similarity matrix for the plurality of feature vectors; a rating interface configured to accept user input of a rating to be associated with each of a subset of the plurality of feature vectors; a search interface configured to accept user input of a rating level criterion and a probability criterion; and a semi-supervised learning processor configured to use a semi-supervised learning algorithm to identify one or more unrated feature vectors meeting both the probability level criterion and the rating level criterion. The system optionally further includes an active learning processor operably coupled to the rating interface, wherein the active learning processor is configured to utilize an active learning algorithm.

Also disclosed herein is a method of quantifying similarities between audio streams, such as a plurality of music recordings, including the steps of providing a plurality of audio streams and applying a multi-task learning algorithm to the plurality of audio streams, wherein the multi-task learning algorithm outputs a plurality of Hidden Markov Models and a plurality of quantitative measures of similarity for the plurality of audio streams. The multi-task learning algorithm preferably employs a Dirichlet process mixture model.

The method may also include extracting a plurality of Mel Frequency Cepstral Coefficients features of each of the plurality of audio streams and inputting the extracted pluralities of Mel Frequency Cepstral Coefficients features to the multi-task learning algorithm. The multi-task learning algorithm may then be applied to the extracted pluralities of Mel Frequency Cepstral Coefficients features. Each of the plurality of Hidden Markov Models may be defined by a set of Hidden Markov Model parameters, and the multi-task learning algorithm may simultaneously learn the set of Hidden Markov Model parameters for each of the Hidden Markov Models.

Optionally, a quantitative measure of similarity matrix for the plurality of audio streams may be composed from the plurality of quantitative measures of similarity output by the multi-task learning algorithm. The quantitative measure of similarity matrix may be normalized into a probability matrix. An Eigen analysis may be performed on the probability matrix, thereby defining a multi-dimensional diffusion space. Further, at least some of the plurality of audio streams may be displayed in at least two, or, in some embodiments of the invention, at least three dimensions of the multi-dimensional diffusion space.

Also disclosed is a method of quantifying similarities between a plurality of sequential data streams, such as audio streams, video streams, financial data streams, or genetic data streams, including the steps of: accessing a plurality of sequential data streams; applying a multi-task learning algorithm to the plurality of sequential data streams, wherein the multi-task learning algorithm outputs a plurality of Hidden Markov Models and a plurality of quantitative measures of similarity for the plurality of sequential data streams; and composing a quantitative measure of similarity matrix for the plurality of sequential data streams from the plurality of quantitative measures of similarity output by the multi-task learning algorithm. The plurality of sequential data streams may be analog or digital.

The quantitative measure of similarity matrix may be used to map at least some of the plurality of sequential data streams to a multi-dimensional diffusion space. In some embodiments of the invention, this includes: normalizing the quantitative measure of similarity matrix into a probability matrix; performing an Eigen analysis on the probability matrix, thereby defining the multi-dimensional diffusion space; and mapping at least some of the plurality of sequential data streams to the multi-dimensional diffusion space.

The method may also include the steps of: defining at least one feature vector for each of the plurality of sequential data streams; and inputting the defined at least one feature vector for each of the plurality of sequential data streams to the multi-task learning algorithm.

In another aspect of the invention, a method of quantifying similarities between a plurality of sequential data streams, includes providing a plurality of sequential data streams and designing a plurality of Hidden Markov Models, each of the plurality of Hidden Markov Models modeling at least a portion of each of the plurality of sequential data streams and being defined by a set of Hidden Markov Model parameters. The step of designing a plurality of Hidden Markov Models typically includes jointly learning the set of Hidden Markov Model parameters for each of the plurality of Hidden Markov Models, and may also include jointly learning quantitative measures of similarity between the plurality of sequential data streams.

The present invention also provides a system for quantifying similarities between a plurality of sequential data streams. The system generally includes a multi-task learning processor that applies a multi-task learning algorithm to the plurality of sequential data streams and that outputs a plurality of Hidden Markov Models and a plurality of quantitative measures of similarity for the plurality of audio streams; and a matrix composition processor that composes a quantitative measure of similarity matrix for the plurality of sequential data streams from the output of the multi-task learning processor. Optionally, the system further includes a storage medium upon which the plurality of sequential data streams is stored.

An optional Eigen analysis processor performs an Eigen analysis on the quantitative measures of similarity matrix, thereby defining a multi-dimensional diffusion space, while an optional mapping processor maps at least some of the plurality of sequential data streams to the multi-dimensional diffusion space in at least two, or, in some embodiments of the invention, at least three dimensions of the multi-dimensional diffusion space. An output device may be provided to display the mapping of at least some of the plurality of sequential data streams to the multi-dimensional diffusion space. A sorting processor may also be provided to sort two or more of the plurality of sequential data streams according to quantitative measures of similarity between each of the two or more of the plurality of sequential data streams and a selected sequential data stream.

In still another embodiment, the invention provides a system for quantifying and representing similarities between audio streams that includes: a storage device on which is stored a plurality of audio streams; a feature vector processor that defines at least one feature vector for each of the plurality of audio streams; and a multi-task learning processor that applies a multi-task learning algorithm to the defined at least one feature vector for each of the plurality of audio streams and that outputs a plurality of Hidden Markov Models and a plurality of quantitative measures of similarity for the plurality of audio streams.

In some embodiments, the system also includes a matrix composition processor that composes a quantitative measure of similarity matrix for the plurality of sequential data streams from the output of the multi-task learning processor. The quantitative measure of similarity matrix may be expressed in terms of random walk probability, such that an optional spectral analysis processor may perform an Eigen analysis on the quantitative measure of similarity matrix and define a multi-dimensional diffusion space.

The system may also include one or more of a mapping processor that maps at least some of the plurality of audio streams to a map of at least two dimensions of the multi-dimensional diffusion space and a sorting processor that sorts two or more of the plurality of audio streams according to quantitative measures of similarity between each of the two or more of the plurality of audio streams and a selected audio stream. An output device may be configured to output the map and/or the sorted list of audio streams.

An advantage of the present invention is that it provides a quantitative measure of similarity between sequential data streams that takes into consideration the time-evolving properties of the data streams.

Another advantage of the present invention is that the quantitative measure of similarity may be used to rank-order sequential data streams according to their similarity, taking into account not only the features of the data streams, but also how those features changed over time.

Still another advantage of the present invention is that the quantitative measure of similarity may be used to map the sequential data streams to a graphical representation of a multi-dimensional diffusion space, thereby providing a graphical representation of the relationship and similarities between sequential data streams.

Yet another advantage of the present invention is that the quantitative measure of similarity may be used to provide a user-specific recommendation system that identifies data streams similar to those liked by a particular user.

A further advantage of the present invention is that it provides for semi-supervised and active learning modes that may be employed to make personalized recommendations of unrated data streams based on a user's rating of other data streams.

The foregoing and other aspects, features, details, utilities, and advantages of the present invention will be apparent from reading the following description and claims, and from reviewing the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flowchart illustrating steps that may be carried out in computing a quantitative measure of similarity between sequential data streams, and in particular audio streams.

FIG. 2 is a flowchart illustrating steps that may be carried out in representing similarities between sequential data streams, and in particular audio streams.

FIG. 3 depicts a graphical representation of a plurality of audio streams mapped to a multi-dimensional diffusion space, and is presented in both black and white and color versions.

FIG. 4 depicts an exemplary graphical user interface for searching and rank-sorting audio streams according to similarities therebetween.

FIG. 5 is a flowchart of a semi-supervised learning process for rating of data streams.

FIG. 6 is a flowchart of an active learning process for rating of data streams.

FIG. 7 illustrates an exemplary graphical user interface for searching and recommending audio streams, and is presented in both black and white and color versions.

### DETAILED DESCRIPTION OF THE INVENTION

The present invention provides a method and system for quantifying and representing similarities in data streams. The present invention can be practiced to good advantage, and will be described herein, in the context of sequential data streams. The term “sequential data stream” refers to a stream of time-evolving data. Thus, by way of example only, and without limitation, the term “sequential data stream” encompasses data streams such as audio streams (e.g., musical and spoken-word recordings), video streams, financial data streams (e.g., time-evolving profit data, price data, revenue data, or time-evolving data about the number of employees working for a particular company), and genetic data.

For the sake of explanation, the present invention will be described in connection with audio streams, and in particular in connection with musical recordings (e.g., tracks in a music library, including songs, spoken-word tracks, and the like). One of ordinary skill in the art will appreciate, however, that the present invention may also be practiced in connection with data streams generally, both analog and digital and whether sequential or non-sequential. Thus, in addition to practicing the present invention in the context of the sequential data streams mentioned above, the teachings disclosed herein could also be applied to such non-sequential data streams as food and wine chemical spectra, for example to quantify and represent similarities between various wines or foods, without departing from the spirit and scope of the present invention.

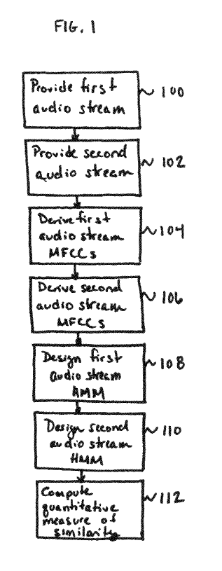

FIG. 1 is a flowchart illustrating a method that may be used to quantify similarities between audio streams. In step 100, a first audio stream (e.g., a first musical recording) is provided. Likewise, in step 102, a second audio stream (e.g., a second musical recording) is provided.

As one of ordinary skill in the art will understand, audio streams may be represented by their Mel-frequency cepstral coefficients (MFCC) features. Thus, it is desirable to identify or derive a plurality of MFCC features of at least a portion of the first audio stream and a plurality of MFCC features of at least a portion of the second audio stream in steps 104 and 106, respectively. This may be done, for example, by sampling the audio streams at about 22 kHz, dividing each audio stream into non-overlapping frames of about 25 ms each, and extracting ten-dimensional MFCC features for each frame. MFCCs are further described in Md. Khademul Islam Molla and Keikichi Hirose, “On the effectiveness of MFCCs and their statistical distribution properties in speaker identification,” IEEE Int. Conf. Virtual Environments, Human-Computer Interfaces and Measurements Systems, Boston, Mass., 12-14 Jul. 2004, which is hereby incorporated by reference as though fully set forth herein.

It should be understood that, in addition to the use of MFCCs, it is within the spirit and scope of the present invention to utilize other modelable representations of the first and second audio streams. It should further be understood that features analogous to MFCCs may be used to represent other sequential data streams. For example, a stream of financial data may be represented by daily stock prices or monthly profits for a given period of time. The term “feature vector” will be used herein to describe such a representation of a data stream. A user may customize the feature vector based on the underlying data stream. For example, with a data stream that represents genetic information, the feature vector may be selected on one or more genetic traits or features (e.g., blue eyes, curly hair, etc.). Similarly, where the underlying data stream is a chemical analysis for wine or food, the feature vector may be selected based on one or more specific aromas or taste preferences (e.g., butter, smoke, mint, pepper, etc.).

Returning once again to the music context, if one considers music to be a set of concurrently-played notes, with each note defining a location in feature space, and note transitions, which are time-evolving features, music can be represented as a time series, and thus modeled by a Hidden Markov Model (HMM). Accordingly, in step 108, a first statistical model, which is preferably a first HMM, is designed for at least a portion of the first audio stream. Likewise, in step 110, a second statistical model, which is preferably a second HMM, is designed for at least a portion of the second audio stream. Preferably, the first and second HMMs are designed to model the MFCCs of the first and second audio streams derived in steps 104 and 106 respectively. Of course, other models may be used to model the first and second audio streams without departing from the spirit and scope of the present invention. The use of HMMs is advantageous, however, in that HMMs quantify not only the modeled features of the audio streams (e.g., the MFCCs), but also how those features evolve over time. This is unlike other statistical models, such as Gaussian Mixture Models (GMMs), which typically model segments of the audio streams in isolation, and thus do not account for the time-evolving properties of the audio streams.

As music often follows a deliberate structure, the underlying, hidden mechanism of that music need not be viewed as homogenous, but rather can be viewed as originating from a mixture of HMMs (that is, a plurality of HMM states). To this end, the number of HMM states in at least one of the first and second HMMs may be determined non-parametrically. Preferably, the number of HMM states in both of the first and second HMMs is determined non-parametrically. By “non-parametric,” it is meant that the number of HMM states is specified a priori, which can be contrasted with ad hoc determination of the number of HMM states (arbitrarily setting the number of HMM states). That is, the number of HMM states may be treated as essentially “infinite” or unbounded, and a posterior estimate on the proper number of HMM states may be learned based on the audio stream being modeled. Accordingly, it should be understood that the first HMM and the second HMM may each have the same number of HMM states or a different number of HMM states depending upon the first and second audio streams.

One suitable way to non-parametrically determine the number of HMM states in the present invention is by utilizing a variational Bayes inference algorithm. In some embodiments of the invention, the variational Bayes algorithm is based upon the Dirichlet process (e.g., a Dirichlet process prior). As one of ordinary skill in the art will recognize, the Dirichlet process is a clustering algorithm, and the states of a HMM may represent clusters sampled sequentially. A variational Bayes algorithm is an efficient framework for determining the posterior density function on the model parameters and on the number of HMM states. The use of a Dirichlet process to non-parametrically determine the number of HMM states is further described in Yuting Qi, John William Paisley and Lawrence Carin, “Music Analysis Using Hidden Markov Mixture Models,” published in IEEE Transactions on Signal Processing, Vol. 55, No. 11 (November 2007), which is hereby incorporated by reference as though fully set forth herein.

Once the first and second HMMs have been designed for the first and second audio streams, they may be used to compute a quantitative measure of similarity between the first audio stream and the second audio stream in step 112. The quantitative measure of similarity computed from the first and second HMMs will typically be expressed in probabilistic terms. For example, the quantitative measure of similarity may be expressed as the probability that data synthesized by the first HMM would have been synthesized by the second HMM or vice versa. In the context of audio streams, the first and second HMMs may be used to synthesize MFCC features or any other suitable representation of an audio stream modeled by the HMMs. In preferred embodiments of the invention, both probabilities are computed and then averaged in arriving at the quantitative measure of similarity between the first and second audio streams, such that larger values of the quantitative measure of similarity (e.g., probabilities closer to 1) reflect greater similarity between the first and second audio streams.

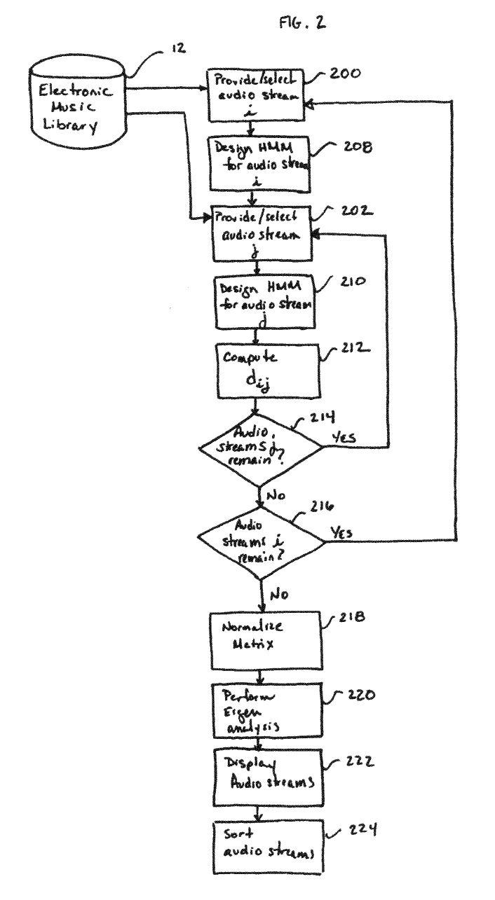

The method described above advantageously provides a quantitative measure of similarity between a pair of data streams, and in particular sequential data streams, that takes into account how the data evolves over time. The method may also be employed to represent similarities between a plurality of data streams, for example as depicted in the flowchart of FIG. 2. In FIG. 2, steps similar to those depicted in FIG. 1 are shown with similar reference numerals (e.g., step 200 is similar to step 100, and step 202 is similar to step 102). In order for the nested loops described below to be presented without confusing the flowchart of FIG. 2, the steps carried out in FIG. 2 are not presented in the same order as they are in FIG. 1. One of ordinary skill in the art will appreciate, however, that this is a matter of convenience in illustration only, and is not intended to limit the invention to the particular sequence of steps depicted.

As shown in FIG. 2, the first audio stream and the second audio stream may be provided by selecting them from amongst a plurality of audio streams stored in electronic music library 12. Electronic music library 12 may represent, for example, a user's personal music library (e.g., a music library stored on an individual's personal computer, such as an ITUNES® library), an online catalog of music (e.g., a catalog of music available from an online music vendor, such as the ITUNES MUSIC STORE®), the music stored on a portable audio player (e.g., an individual's IPOD®), or any other suitable source of audio streams, including combinations of the above.

Electronic music library 12 may be stored in any suitable storage medium, such as a hard disk or optical disk, and in any suitable location or locations (e.g., on a local machine or on a server accessible over a local- or wide-area network connection such as the Internet). Electronic music library 12 may also span multiple storage media on multiple computer systems connected via a network (e.g., the Internet).

For notational convenience, the first audio stream selected in step 200 will be referred to as audio stream i, while the second audio stream selected in step 202 will be referred as audio stream j. Further, the quantitative measure of similarity between audio stream i and audio stream j computed in step 212 will be denoted dᵢⱼ.

In block 214, a decision is made whether electronic music library 12 contains additional audio streams for which it is desired to calculate a quantitative measure of similarity relative to audio stream i. If so, a new audio stream j may be selected from electronic music library 12 in a loop that returns the process of FIG. 2 to step 202. By iteratively looping through the process of FIG. 2, a vector of quantitative measures of similarity for audio stream i may be computed. This vector (referred to as a “quantitative measure of similarity vector” or a “vector of quantitative measures of similarity” for audio stream i) is composed of the quantitative measures of similarity between audio stream i and at least some of, and preferably all of, the other audio streams in electronic music library 12, with each component of the vector being computed in a single iteration of the inner loop of the flowchart of FIG. 2.

Of course, the flowchart of FIG. 2 may also be repeated for each audio stream i in electronic music library 12. That is, a vector of quantitative measures of similarity may be computed for each audio stream in electronic music library 12, as shown in decision block 216 and the outer loop of the flowchart of FIG. 2. These vectors may then be composed into a matrix of quantitative measures of similarity (also referred to as a “quantitative measure of similarity matrix”) for electronic music library 12. For an electronic music library containing N audio streams, the matrix of quantitative measures of similarity will be an N×N matrix, and each of the N² entries in the matrix is the quantitative measure of similarity computed between the corresponding row and column audio streams. If desired, the matrix of quantitative measures of similarity may also be expressed as a graph, wherein the nodes of the graph are the N audio streams and the strength of the connection between nodes is represented by the quantitative measure of similarity therebetween (e.g., the strength of the connection between the node for audio stream i and the node for audio stream j is dᵢⱼ). In general, either the matrix of quantitative measures of similarity or its associated graph provides a quantitative measure of similarity for each pair of audio streams i and j within electronic music library 12, with higher values of dᵢⱼ (e.g., values closer to 1) associated with more similar audio streams i and j.

In step 218, the matrix of quantitative measures of similarity may be normalized into a probability matrix of probabilities p(j|i). The matrix of quantitative measures of similarity may be normalized by dividing each value in a row of the matrix (e.g., each quantitative measure of similarity in a vector of measures of quantitative similarity) by the sum of all values in the row, such that each row in the probability matrix sums to one. Thus, the normalized probability matrix quantitatively expresses similarities between audio streams in conditional probability terms. Stated differently, each entry in the probability matrix is a probability of walking between the corresponding row and column audio streams in a single step on a random walk on a graph of the probability matrix, with higher probabilities p(j|i) (e.g., values closer to 1) reflecting more similar audio streams.

The present invention may also be practiced to provide a desirable graphical representation of electronic music library 12. In step 220, a spectral analysis, such as an Eigen analysis, is performed on the probability matrix, thereby defining a multi-dimensional space (referred to herein as an “eigenspace,” “diffusion space,” or “mapping space”) into which the audio streams in electronic music library 12 may be mapped. For an electronic music library containing N audio streams, the multi-dimensional eigenspace will have N dimensions. In step 222, at least some, and in some embodiments all, of the audio streams in electronic music library 12 may be displayed in at least two dimensions of the eigenspace, and preferably in at least three dimensions of the eigenspace, for example by plotting points on a graphical representation of the eigenspace. This may be accomplished, for example, by plotting the audio streams according to the appropriate number of dominant eigenvectors (e.g., those eigenvectors with the largest eigenvalues).

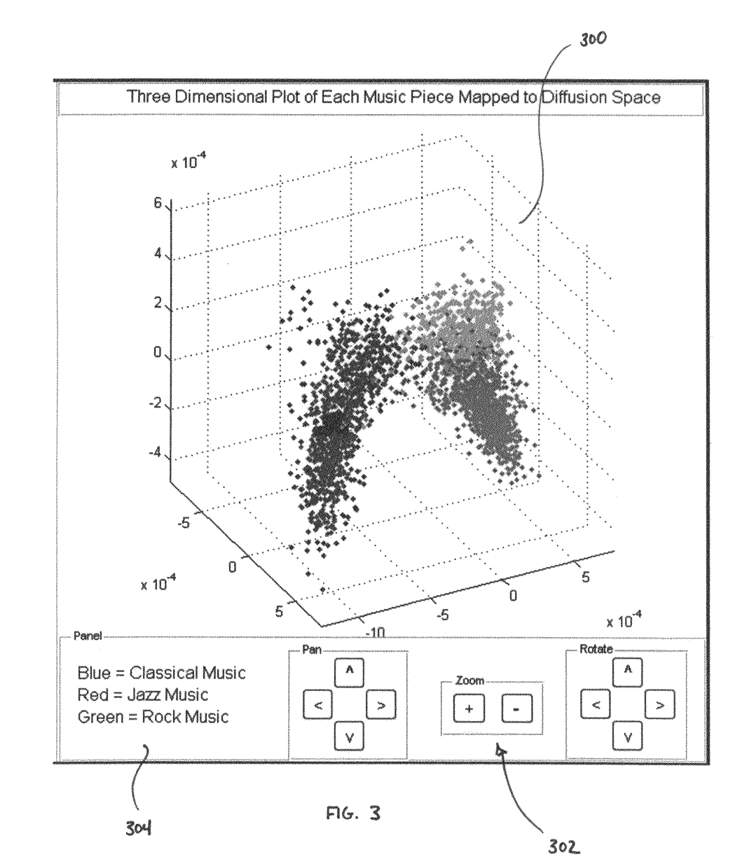

FIG. 3 depicts a graphical representation 300 of an electronic music library containing 2500 audio streams in three dimensions of the diffusion space, plotted according to their three dominant eigenvectors. Each point on the graphical representation represents one of the 2500 audio streams within an electronic music library. Similar audio streams appear closer to each other in the diffusion space. It should be understood, however, that the audio streams that graphically appear closest in graphical representation 300 may not, in fact, be the absolute closest, as the graphical representation typically will represent fewer than all dimensions of the eigenspace. For example, in an electronic music library containing 2500 audio streams, the eigenspace will have 2500 dimensions in which similarities may be calculated (described in further detail hereinafter), though, as described above, only three of those dimensions may be graphically represented at any one time.

As shown in FIG. 3, graphical representation 300 may be part of a graphical user interface that also provides a control panel 302 including manipulation controls to pan, zoom, and rotate graphical representation 300 on one or more axes in order to “explore the music landscape” of the electronic music library. While FIG. 3 is depicted from a fixed perspective, the n-dimensional drawing (e.g., the two- or three-dimensional graphical representation 300) may be rotated about any of its n axes. A software tool preferably provides the user with the ability to change the perspective from which graphical representation 300 is viewed to facilitate viewing the mapping space. Another software tool may give the user the ability to zoom in or out on a portion of the space.

Further, the points representing the plotted audio streams may be color-coded or otherwise distinguished from one another according to one or more user-defined criteria. For example, as indicated by legend 304, color codes may be assigned based on genre metadata associated with the audio streams, which may be included within an audio stream's ID3 tag. As illustrated in FIG. 3, the mapped data points are color-coded with red, blue, and green to indicate genre—jazz, classical, and rock, respectively—with audio streams within the same genre being generally grouped together in graphical representation 300, indicating, as one might expect, that they are generally similar to one another.

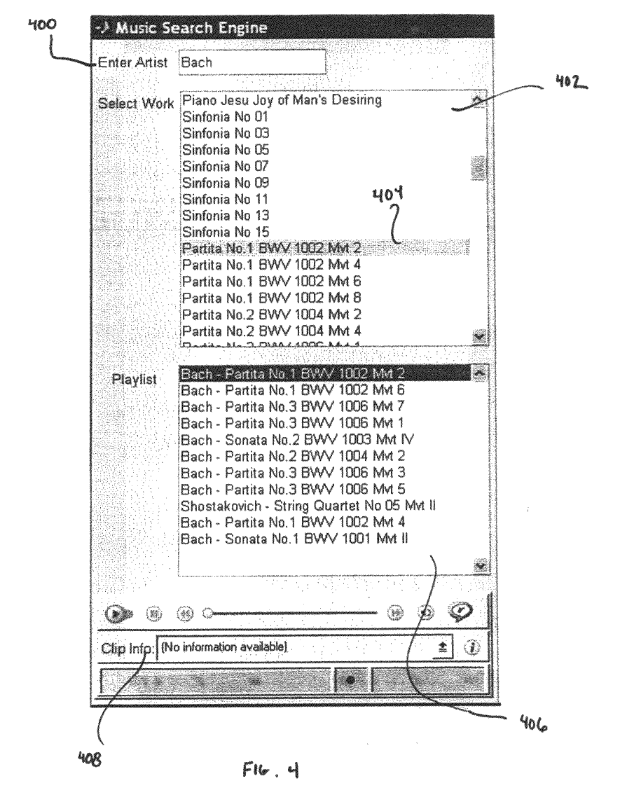

Additional aspects of graphical representation 300 are also contemplated. In some embodiments of the invention, the points representing the plotted audio streams may be associated with hyperlinks, such that hovering over a particular point with a mouse reveals metadata (e.g., song title, artist, album, etc. retrieved from an ID3 tag) about the audio stream represented by that point. Clicking on the point may also be used to initiate playback of the audio stream represented thereby and/or to update search results (described in connection with FIG. 4, below). It is also contemplated that graphical representation 300 may be windowed—that is, split up into various segments, much like a magnification effect—in order to clearly represent the electronic music library. Windowing is desirable, for example, where outlying audio streams skew the scale of the graphical representation of the electronic music library such that it is difficult to distinguish clustered audio streams from one another in at least one dimension.

In addition to representing an electronic music library graphically, one or more audio streams may be sorted in step 224 in a similarity-ranked order relative to a selected audio stream, for example as shown in FIG. 4, which again depicts an aspect of a graphical user interface that may be utilized in connection with the present invention. In particular, FIG. 4 depicts a search interface. For example, in search criteria box 400, a user may type the name of an artist of interest, such as Bach. Of course, the user may also search the electronic music library by other criteria, including, but not limited to, title keyword, genre, album, label, and year of release; searches may also be constructed using a combination of criteria (e.g., artist and year of release or genre and title keyword). Results box 402 may then display all audio streams in the electronic music library matching the search criteria input in search box 400 (e.g., all songs by Bach). One of the audio streams 404, such as “Partita No. 1 BWV 1002 Mvt 2” may then be selected by a user. In playlist window 406, at least a subset of the plurality of audio streams in the electronic music library is sorted according to similarity to the selected audio stream. For example, in FIG. 4, the most similar audio stream in the illustrated electronic music library is “Partita No. 1 BWV 1002 Mvt 6,” followed by “Partita No. 3 BWV 1006 Mvt 7,” and so on. Rather than displaying the entirety of the electronic music library, it is contemplated that playlist window 406 may display only those audio streams in the electronic music library that are within a certain preset similarity threshold, which may be user-selectable, to the selected audio stream 404. Alternatively, or in addition, the search may be constructed to retrieve a preset number of most similar audio streams (e.g., the ten most similar or closest audio streams), which number may also be user-selectable.

The graphical user interface may also provide media player panel 408 to playback and provide information about audio streams as desired. Media player panel 408 and playlist window 406 may be collectively referred to as a “playlist interface.”

In some embodiments of the invention, the audio streams are sorted in playlist window 406 according to their distances (e.g., their Euclidean distances, denoted herein as Dᵢⱼ) from the audio stream selected in results box 402. These distances may be Euclidean distances calculated from the positions of the audio streams in the eigenspace. However, it is also within the spirit and scope of the present invention to sort according to any suitable measure of distance between audio streams. For example, rather than calculating Euclidean distances in the eigenspace, Euclidean distances may be calculated from either the matrix of quantitative similarity measures or the probability matrix. Preferably, Euclidean distances are calculated using all dimensions of the multi-dimensional eigenspace, rather than just those dimensions used in graphical representation 300, thereby providing a highly robust model of the relationship and similarities between audio streams in the electronic music library. As an alternative to Euclidean distance, audio streams in playlist window 406 may be sorted according to their quantitative measures of similarity relative to the audio stream selected in results box 402 (recall that more similar audio streams are associated with larger quantitative measures of similarity dᵢⱼ).

In addition to rank-sorting audio streams according to similarities therebetween, the present invention may also be used to calculate a confidence value in the similarity between two audio streams. Confidence values numerically express a confidence that audio streams are similar, and are typically expressed as a ratio of a quantitative measure of similarity or distance between audio streams to a maximum or minimum value thereof, as appropriate. It is contemplated that confidence values may be used in conjunction with the rank-sorted list of audio streams (e.g., playlist window 406) as a quantitative measure of how similar the most similar audio streams are. For example, suppose that the audio stream selected in results box 402 is an “outlier.” Though the selected audio stream is quantitatively highly dissimilar from other audio streams in the electronic music library, there will nonetheless be a most similar audio stream that will appear at the top of rank-sorted list displayed in playlist window 406. A low confidence value associated with the most similar audio stream will indicate, however, that the most similar audio stream is not highly similar to the selected audio stream, providing a quantitative indication that the selected audio stream is an outlier, and indicating to the user that the audio streams that are most similar are not highly similar.

One suitable equation for a confidence value is the equation

$${c}_{ij} = \frac{{d}_{ij}}{{d}_{ij , max}} ,$$

where d_{ij,max} is a maximum quantitative measure of similarity in the matrix of quantitative measures of similarity for the audio stream i (e.g., the highest value in the matrix of quantitative measures of similarity), such that a confidence value of one implies maximum confidence (e.g., the audio streams are highly similar) and a confidence value of zero implies no confidence (e.g., the audio streams are highly dissimilar). Of course, the confidence value may be calculated from the normalized probability matrix instead of, or in addition to, the matrix of quantitative measures of similarity. The confidence value may also be calculated from Euclidean distances between audio streams, which, as described above, may be computed in the eigenspace or from either the matrix of quantitative measures of similarity or the probability matrix. One of ordinary skill in the art will appreciate how to define one or more suitable confidence values from the teachings herein.

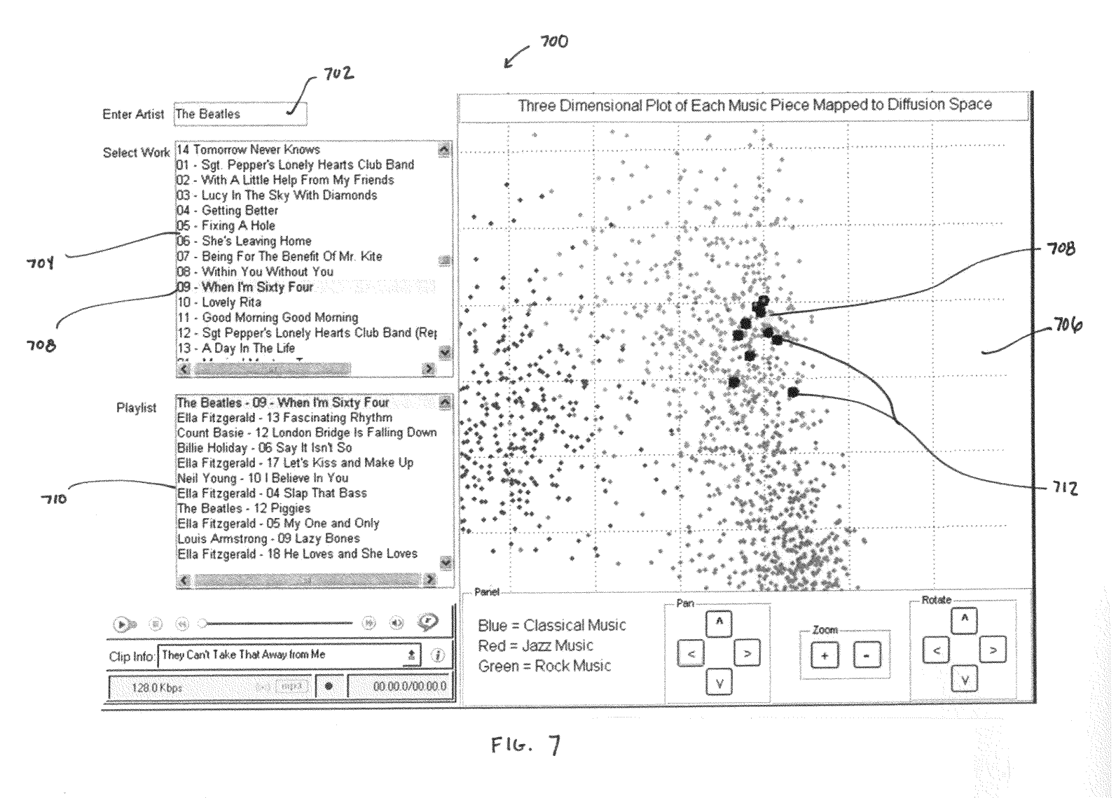

FIG. 7 illustrates an exemplary graphical user interface 700 for a music search engine combining the graphical representation of the electronic music library described in connection with FIG. 3 and the search interface described in connection with FIG. 4. Thus, search criteria box 702 permits a user to input an artist of interest. Of course, search criteria box 702 could also permit input of other user criteria (e.g., genre of interest, song keywords, record labels, and the like, as well as combinations thereof). Results list 704 shows the results of applying the search criteria specified in search block 702 to the electronic music library being searched. Likewise, window 706 graphically represents the electronic music library in the diffusion space as described above in connection with FIG. 3. The user may then select one or more results 708 from results list 704; the selected audio streams may also be highlighted in window 706. In playlist window 710, a recommended playlist of the most similar (e.g., closest) audio streams is generated; some or all of the audio streams 712 in the playlist may also be highlighted in window 706.

As described above in connection with FIG. 4, the playlist shown in window 710 may be constituted according to any suitable algorithm. For example, it may contain every audio stream in the electronic music library that falls within a preset distance of the selected audio stream 708. Alternatively, or in addition, it may contain a particular number of closest audio streams to the selected audio stream 708 (e.g., the ten closest audio streams). In still other embodiments, the playlist may be constituted using a semi-supervised learning process, a rating level threshold, and a probability threshold, as will be described in further detail below.

The graphical representation of the electronic music library displayed in window 706 may also be hyperlinked. Thus, if a user hovers a mouse pointer over a particular dot in the graphical representation, identifying information about the associated audio stream (e.g., metadata from an ID3 tag) may be displayed in a pop-up window. Further, if the user clicks on a particular dot in the graphical representation, it may change the selected audio stream and update the contents of playlist window 710 accordingly.

As described above, it is within the spirit and scope of the present invention to represent similarities between a plurality of non-sequential data streams, such as food or wine chemical spectra, and/or to rank-sort the non-sequential data streams accordingly. Thus, in general, substantially any matrix of quantitative measures of similarity for a plurality of data streams may be normalized into a probability matrix, and an Eigen analysis may be performed thereon to define a multi-dimensional eigenspace. The data streams may then be plotted in a graphical representation of the eigenspace and/or sorted according to Euclidean distances or quantitative measures of similarity as described above.

The methods described above may be advantageously used to graphically represent and/or organize a digital music library, such as might be found on an individual's portable MP3 player or computer. For example, a user may select a particular song in the music library and automatically generate a playlist of similar songs therefrom. It may also be utilized to identify music in a first electronic music library that is similar to music in a second electronic music library, for example in order to automate or facilitate sharing of similar music between different users' electronic music libraries or to identify newly added songs similar to those already purchased or downloaded by a particular user.

One of ordinary skill will recognize that it may not be appropriate to process all of the plurality of audio streams (or other data streams) as a single task. The audio streams may, however, be correlated to some extent, such that processing them independently may disregard information that may properly and beneficially be shared between audio streams. Thus, in another aspect of the present invention, a multi-task learning algorithm may be employed in quantifying the similarities between audio streams (such as musical recordings, spoken word recordings, and the like). The term “multi-task learning algorithm” is used herein to refer to an algorithm that designs the HMMs for all of the audio streams (or other sequential data streams) simultaneously, instead of on a recording-by-recording (“single task learning”) basis as described above. Multi-task learning algorithms are described in further detail in Y. Xue, X. Liao, L. Carin and B. Krishnapuram, “Multi-task learning for classification with Dirichlet process priors,” J. of Machine Learning Research, Vol. 8 pp. 35-63, January 2007, which is hereby incorporated by reference as though fully set forth herein.

As described above, MFCC features may be extracted from each musical recording, such that each musical recording may be represented by a sequence of vectors, with each vector in the sequence corresponding to MFCC features. Typically, each MFCC vector will be extracted over a contiguous subset of the musical recording, and the time sequence of MFCC features will correspond to the time evolution of the musical recording. HMMs can then be designed for each of the musical recordings using the extracted MFCC feature vectors.

For example, assuming that there are N audio streams within the electronic music library being modeled, the notation HMMₙ may be used to denote the HMM for the n^{th} musical recording (n=1, 2, . . . , N). One of skill in the art will appreciate that HMMₙ may be characterized by a set of HMM parameters, θₙ. As described herein, the HMM for the n^{th} musical recording may be designed using either a single-task learning algorithm or a multi-task learning algorithm.

In contrast to a single-task learning algorithm, wherein the HMMs are designed in isolation from each other, a multi-task learning algorithm can utilize the similarities in MFCC feature vectors for different musical recordings to enhance the quality of the HMMs designed for the plurality of musical recordings. That is, a multi-task learning algorithm learns the parameters θₙ for all N musical recordings jointly, instead of on a recording-by-recording basis. Advantageously, the multi-task learning algorithm simultaneously calculates the quantitative measures of similarity (e.g., the values dᵢⱼ) between musical recordings during the model-design process, thereby increasing computational efficiency and reducing the amount of processing overhead required. Of course, these quantitative measures of similarity may be composed into a quantitative measure of similarity matrix as described above, which may be further processed and/or analyzed as described in detail herein.

The multi-task learning algorithm according to the present invention preferably employs a Dirichlet process mixture model. The Dirichlet process framework automatically determines which of the musical recordings are appropriate for data sharing in the multi-task learning algorithm and which are not. For example, recordings of classical music from the same artist or era may be sufficiently similar to benefit from data sharing when designing HMMs, while recordings of classical music and recordings of rock music may be too dissimilar to benefit from data sharing. Data sharing may also reduce the amount of data required of each of the sequential data streams being modeled, which may also beneficially increase computational efficiency and reduce processing overhead.

Moreover, by quantifying similarities between musical recordings, the present invention may also be employed to good advantage in connection with a music rating and recommendation system, which may be tailored to or trained for the likes and dislikes of particular individuals. It is not uncommon for an electronic music library to provide the library's owner or user with the ability to rate musical pieces therein according to personal tastes. For example, ITUNES® permits users to rate items in the electronic music library on a scale from zero to five stars. The present invention leverages such rating information and quantitative measures of similarity not only to make classification decisions based on all available data streams, both rated and unrated, but also to adaptively determine which musical recordings an individual should listen to and rank. The former is termed “semi-supervised learning,” while the latter is termed “active learning,” and the two may advantageously be employed in conjunction in practicing the present invention.

As used herein, the terms “rating” and “rating level” refer to a label assigned to or associated with a data stream, such as an audio stream, indicative of some characteristic thereof, and which may, in some embodiments of the invention, be expressed numerically. Stated differently, a rating classifies an audio stream into a particular category chosen from a plurality of categories. Thus, in the present invention, ratings may be regarded as being selected from a plurality of ratings.

In some embodiments of the invention, the plurality of ratings contains two discrete ratings, such as “like” and “dislike.” In other embodiments of the invention, the plurality of ratings includes additional discrete ratings—for example, a scale of zero to five stars, a scale of one to ten, a “thumb scale” (e.g., two thumbs up, one thumb up, one thumb down, two thumbs down, etc.), and the like. In still other embodiments of the invention, the plurality of ratings is a continuous “sliding scale,” permitting a high degree of flexibility in the rating associated with a particular audio stream.

Though the examples of ratings given above generally relate to how well a particular data stream is liked (e.g., a level of interest in the data stream), the terms “rating” and “rating level” are intended to encompass all possible categorizations and classifications of data streams, including classification of audio streams by genre, musical era, and the like, and classification of wines by vintage, region, and quality (e.g., on a scale of 50-100 points) to name just a few. For purposes of this description, however, the rating will be described as a rating of either “like” or “dislike,” and this binary plurality of ratings will be represented as 1 and 0, respectively. The rating associated with an audio stream i will be denoted herein as rᵢ. Thus, rᵢ=1 indicates that the audio stream i is liked, while rᵢ=0 indicates that the audio stream i is disliked. One of ordinary skill in the art will understand how to generalize, extend, and apply the teachings herein to larger, non-binary pluralities of ratings.

The learning processes described herein can be conducted utilizing information stored locally and/or remotely. For example, with an active learning scheme, music stored on a remote location may be played via an intranet or the Internet for purposes of having the user rate it; alternatively, the music may be stored on a local device and then presented to the user for rating. Similarly, with a semi-supervised learning scheme, the music database of the user as stored on a local device may be analyzed at the device or remotely via an intranet or the Internet. The resulting data may then be stored on a local device or may alternatively be stored at a remote location that is itself accessible via an intranet or via the Internet.

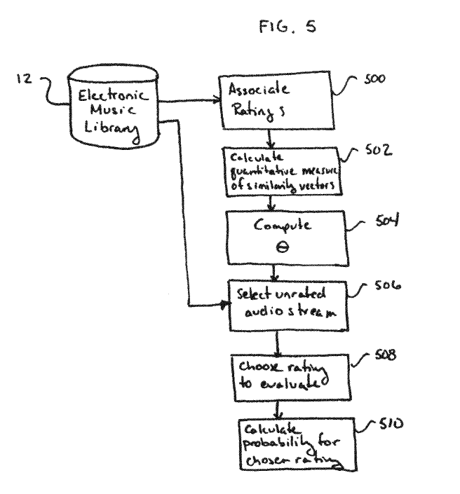

FIG. 5 is a flowchart of a semi-supervised method of rating audio streams according to an embodiment of the present invention. A plurality of audio streams, such as those contained in electronic music library 12, is provided. In step 500, a rating selected from a plurality of ratings is associated with each of a subset of the plurality of audio streams. Thus, the plurality of audio streams may be viewed as including both a plurality of rated audio streams (denoted herein as N_{R}) and a plurality of unrated audio streams (denoted herein as N_{U}). Typically, the plurality of unrated audio streams will be much larger than the plurality of rated audio streams (that is, there will be many more unrated audio streams than there are rated audio streams). Preferably, there will be at least two rated data streams, and more preferably at least three data streams, though it is contemplated that the invention may be practiced with as few as one rated data stream. Rating information may be acquired, for example, through feedback on purchased or downloaded music (e.g., by rating songs in electronic music library 12 as a user listens to them), or through the specific request of the user to listen to and rate certain audio streams.

A quantitative measure of similarity vector may be calculated for each rated audio stream in step 502. As described above, a quantitative measure of similarity vector expresses quantitative measures of similarity between the rated audio stream and each other audio stream in the plurality of audio streams. It is contemplated that the quantitative measure of similarity vectors may be calculated according to the methods disclosed herein (e.g., using HMMs for the audio streams in the plurality of audio streams and/or expressed in normalized fashion) or any other suitable method.

As described above, each audio stream within electronic music library 12 may be represented by a feature vector x, such as an MFCC feature vector. For example, a vector quantization may be performed across all pieces of music, breaking the complete space of MFCC features into a set of codes. The feature vector x may represent a histogram associated with a given musical recording, quantifying the probability that each codeword is observed across the corresponding piece of music. One of ordinary skill in the art will recognize that analogous feature vectors may be defined for other types of data streams (e.g., a feature vector of daily stock prices for a stream of financial data).

As described above, one object of the method illustrated in FIG. 5 is to compute a probability that a particular user will like the i^{th} data (e.g., audio) stream based on its corresponding feature vector xᵢ, a process referred to herein as “semi-supervised learning,” as it takes into account both rated and unrated data streams. Expressed mathematically, semi-supervised learning calculates p(rᵢ=1|xᵢ). The probability that rᵢ=1 for feature vector xᵢ may represented in terms of the logistic link function

$$p ( {r}_{i} = 1 \vert {x}_{i} , Θ ) = \frac{1}{[ 1 + exp ( - {Θ}^{T} {x}_{i} ) ]} ,$$

where Θ is a logistic link parameter vector to be learned, and which has dimensionality equal to the dimensionality of the feature vectors x. Accordingly, in step 504, a logistic link parameter vector Θ may be computed for the plurality of audio streams based on the quantitative measure of similarity vectors calculated in step 502.

In some embodiments of the invention, the logistic link parameter vector Θ is learned in a maximum-likelihood sense by learning the parameters that maximize the likelihood

$${\prod }_{i = 1}^{{N}_{R}} {\prod }_{j = 1}^{{N}_{R} + {N}_{U}} p ( i \vert j ) p ( {r}_{i} \vert {x}_{j} , Θ ) ,$$

for example by using an expectation-maximization algorithm. This formula uses the plurality of rated audio streams to learn the logistic link parameter vector Θ, and advantageously results in the similar rating of similar audio streams.

Once the logistic link parameter vector Θ has been learned in step 504, an unrated data stream may be selected from electronic music library 12 in step 506, and a rating may be chosen from the plurality of ratings in step 508. In step 510, a probability that the selected unrated audio stream has the chosen rating is calculated based on the logistic link parameter vector Θ. For example, in the binary rating scheme presented above, it is desirable to calculate the probability that an unrated audio stream will be liked—that is, the probability that a user would assign a rating of 1 to the selected unrated data stream. This probability may be calculated according to the equation

$$p ( {r}_{i} = 1 \vert Θ ) = {\sum }_{j = 1}^{{N}_{R} + {N}_{U}} p ( i \vert j ) p ( {r}_{i} = 1 \vert {x}_{j} , Θ ) .$$

This equation expresses, in essence, a confidence that the selected unrated audio stream will be liked by the user; values close to 1 indicate that the selected unrated audio stream can be confidently recommended to the user.

Of course, steps 508 and 510 may be repeated for additional ratings in the plurality of ratings; by repeating steps 508 and 510 for each rating in the plurality of ratings, it is possible to calculate an expected rating for the unrated audio stream. In addition, it should be understood that steps 506, 508, and 510 may also be repeated for additional unrated data streams as desired.

The semi-supervised learning method described herein may be practiced to recommend one or more unrated audio streams that are potentially of interest to a user by identifying such audio streams using the logistic link parameter vector Θ. To this end, both a rating level criterion or threshold and a probability criterion or threshold may be identified, for example by permitting the user to select either or both of the rating level threshold and the probability level threshold as criteria upon which to search electronic music library 12. The logistic link parameter vector E) may then be used to identify one or more unrated audio streams, wherein each of the one or more unrated audio streams has a probability of having a particular relationship to the rating level threshold that bears a particular relationship to the probability threshold (e.g., one or more unrated audio streams meeting both the rating level criterion and the probability criterion).

Such a semi-supervised learning algorithm could be used to construct many different types of queries to predict a user's preferences and thereby recommend audio streams (or other data streams) to a user. For example, in a zero to five star rating system, a user could request that a playlist be generated of all songs in electronic music library 12 that the user is more likely than not to rate at least three stars. In this case, the rating criterion may be expressed as “greater than or equal to 3 stars” and the probability criterion may be expressed as “greater than 0.5.” Likewise, in the binary rating system described above, a user could request that all songs that the user is at least twice as likely to dislike than to like be excluded from the user's playlist. In this case, the rating level criterion is “equal to 0” and the probability criterion is “greater than ⅔.” Of course, these are merely examples, and one of ordinary skill in the art will understand how to define other permutations for recommending audio streams to a user.

In addition to acquiring rating information as described above (e.g., through random, pseudo-random, or user-directed user feedback), the present invention provides a method of adaptively determining which musical recordings within electronic music library 12 an individual should listen to and rate, a process referred to herein as “active learning.” Advantageously, an active learning process defines and develops the subset of ranked audio streams in order to minimize uncertainty in the calculation of the logistic link parameter vector Θ, which may be quantified in terms of Shannon entropy, thereby learning a user's preferences.

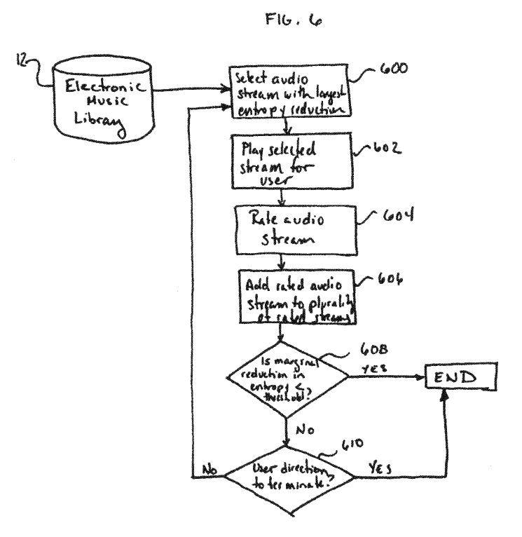

FIG. 6 is a flowchart illustrating an active learning process. In an active learning process, a user is asked to listen to and rank specifically-selected audio streams from within electronic music library 12. The selected audio streams are preferably those that, when ranked, will most reduce the uncertainty in the calculation of the logistic link parameter vector Θ.

In some embodiments of the invention, the process starts by asking the user to rate a coarse sample of the audio streams in electronic music library 12 to set a “baseline” level of knowledge about the user's personal tastes (e.g., asking the user to rate approximately ten randomly selected audio streams from the electronic music library). Thereafter, the process depicted in the flowchart of FIG. 6 may be employed to “home in” on the user's personal tastes.

In step 600, an unrated audio stream that will provide the largest expected reduction in Shannon entropy when rated is selected from electronic music library 12. Stated differently, step 600 selects the unrated audio stream that, when rated, will provide the greatest amount of additional information about the user's personal preferences or tastes. Alternatively, the selected audio stream may be one that, when rated, will reduce the Shannon entropy by an amount in excess of a preset threshold (e.g., not necessarily the largest expected reduction in Shannon entropy, but an expected reduction in Shannon entropy that is above a certain, prespecified level).

In step 602, at least a portion of the selected unrated audio stream, for example a 30-second clip, is played for a user. The user may then be prompted to assign a rating to the selected unrated audio stream. A rating from the plurality of ratings is assigned to the selected audio stream in step 604 (e.g., the user indicates that the user either likes or dislikes the selected audio stream), and the newly-rated audio stream and associated rating is added to the plurality of rated audio streams in step 606.

As one of ordinary skill in the art will understand, each additional audio stream rated provides a marginal expected reduction in Shannon entropy in the calculation of the logistic link parameter vector Θ. Decision block 608 terminates the active learning process when the marginal expected reduction in Shannon entropy in the calculation of the logistic link parameter vector Θ falls below a preset threshold, which may be user-selectable. Of course, if the user no longer wishes to be presented with audio streams to rate, the active learning process may also be user-terminated in decision block 610.

The combination of both semi-supervised learning and active learning is advantageous in that it may be used to provide a system and method for recommending data streams (e.g., data streams from an online or offline music marketplace) that a particular user is most likely to find of interest. For example, a user may participate in an active learning process to rate a certain number of audio streams selected from an electronic music library (e.g., all songs downloadable from an on-line music library), and a semi-supervised learning process may be utilized to recommend one or more audio streams that the user may find of interest. That is, the input provided during the active learning process may be employed to refine the ratings and/or probabilities computed in the semi-supervised learning process. This may be of benefit, for example, in targeted advertising or marketing efforts—once a user's personal musical tastes have been learned through an active learning process, a semi-supervised learning process may be used to solicit the user with advertisements for or notices of other music that the user may enjoy or the dates of concerts that the user may be interested in attending. It may also be beneficial in the discovery of previously unknown or unfamiliar songs or artists. In addition, subsequent purchases, downloads, or ratings by the same user may be used to further refine the user's personalized recommendation system.

In another example of the present invention, a database or catalog of music includes both widely-known and lesser-known audio streams. A user may select a widely-known song that the user likes from a database of songs. A semi-supervised learning methodology, such as that described above, may be used to retrieve, sort, and/or graphically represent one or more lesser-known songs from the database that are most similar thereto, for example by utilizing the quantitative measure of similarity disclosed herein. Of course, the semi-supervised learning methodology could also be utilized to retrieve, sort, and/or graphically represent additional widely-known songs that are most similar to the song selected by the user. The user may then be offered the option to purchase (e.g., fixed price or at auction), download, and/or listen to the retrieved songs.

In still another example of the present invention, a database or catalog of music contains generally lesser-known audio streams. If a user wishes to discover audio streams therein that the user likes, the active learning process described herein could be employed to identify the user's tastes, while the semi-supervised learning process described herein could be employed to recommend one or more suggested audio streams to the user based on the outcome of the active learning process. The user may, of course, be offered the option to purchase, download, and/or listen to the recommended suggested audio streams.

The present invention could also be used by a record label for copyright enforcement. For example, the system and methods disclosed herein could be employed to calculate a quantitative measure of similarity or distance between the accused audio stream and the copyrighted audio stream.

The methods described above may be executed by one or more computer systems, including suitable input, output, and storage devices or interfaces, and may be software implemented (e.g., one or more software programs or modules executed by one or more computer systems of processors), hardware implemented (e.g., a series of instructions stored in one or more solid state devices), or a combination of both. The computer may be a conventional general purpose computer, a special purpose computer, a distributed computer (such as two physically-separated computers that are linked via an intranet or the Internet), or any other type of computer. Further, the computer may comprise one or more processors, such as a single central processing unit or a plurality of processing units, commonly referred to as a parallel processing environment. The term “processor” as used herein refers to a computer microprocessor and/or a software program (e.g., a software module or separate program) that is designed to be executed by one or more microprocessors running on one or more computer systems.

In one embodiment, the processors may be written as separate software modules, but then compiled into a single program that runs on a single microprocessor. One of ordinary skill, however, will understand that the processors may be written separately, compiled separately, and then run on separate microprocessors that may be directly linked or, alternatively, coupled via an intranet or the Internet.

For example, a system for quantifying and representing similarities between sequential data streams may include: a modeling processor configured to design a first HMM of at least a portion of a first member of a pair of sequential data streams and a second HMM of at least a portion of a second member of a pair of sequential data streams; and a comparison processor configured to compute a quantitative measure of similarity between the first and second members of the pair of sequential data streams using the first and second HMMs. By way of further example, each of the processes and decisions identified in FIGS. 1, 2, 5 and 6 can be implemented using one or more computer processors running on one or more computer systems, thereby establishing a computerized system and method for the present invention.

Although several embodiments of this invention have been described above with a certain degree of particularity, those skilled in the art could make numerous alterations to the disclosed embodiments without departing from the spirit or scope of this invention. In particular, though the invention has been described in connection with audio streams, and specifically in connection with music, it is contemplated that the teachings herein may be practiced in connection with any data streams, including, without limitation, those listed herein. For example, the graphical representation of data streams disclosed herein could be used to provide a pictorial representation of a stock portfolio, from which a financial analyst could assess diversity of the portfolio. As another example, the systems and methods disclosed herein may be employed to classify targets detected by acoustic sensing by modeling a sequence of angle-dependent waveforms scattered from the target as one or more HMMs.

Therefore, it is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of quantifying similarities between sequential data streams, the method comprising:
providing a first sequential data stream;
providing a second sequential data stream;
designing a first Hidden Markov Model of at least a portion of the first sequential data stream;
designing a second Hidden Markov Model of at least a portion of the second sequential data stream; and
computing a quantitative measure of similarity between the first sequential data stream and the second sequential data stream using the first Hidden Markov Model and the second Hidden Markov Model.

2. The method according to claim 1, wherein at least one of the first sequential data stream and the second sequential data stream comprises an analog sequential data stream.

3. The method according to claim 1, wherein at least one of the first sequential data stream and the second sequential data stream comprises a digital sequential data stream.

4. The method according to claim 1, wherein the step of computing a quantitative measure of similarity between the first sequential data stream and the second sequential data stream using the first Hidden Markov Model and the second Hidden Markov Model comprises:
synthesizing data using at least one of the first Hidden Markov Model and the second Hidden Markov Model; and
determining a probability that the data synthesized by the at least one of the first Hidden Markov Model and the second Hidden Markov Model would have been generated by the other of the first Hidden Markov Model and the second Hidden Markov Model.

5. The method according to claim 4, wherein the step of determining a probability that the data synthesized by the at least one of the first Hidden Markov Model and the second Hidden Markov Model would have been generated by the other of the first Hidden Markov Model and the second Hidden Markov Model comprises:
determining a probability that data synthesized by the first Hidden Markov Model would have been generated by the second Hidden Markov Model; and
determining a probability that data synthesized by the second Hidden Markov Model would have been generated by the first Hidden Markov Model.

6. The method according to claim 5, wherein the step of computing a quantitative measure of similarity between the first sequential data stream and the second sequential data stream using the first Hidden Markov Model and the second Hidden Markov Model further comprises averaging the probability that data synthesized by the first Hidden Markov Model would have been generated by the second Hidden Markov Model and the probability that data synthesized by the second Hidden Markov Model would have been generated by the first Hidden Markov Model.

7. The method according to claim 1, wherein each of the first sequential data stream and the second sequential data stream comprises a stream of audio data.

8. The method according to claim 1, wherein each of the first sequential data stream and the second sequential data stream comprises a stream of financial data.

9. The method according to claim 1, wherein each of the first sequential data stream and the second sequential data stream comprises a stream of genetic data.

10. A method of representing similarities between a plurality of sequential data streams, the method comprising:
(a) selecting a sequential data stream i from the plurality of sequential data streams;
(b) designing a Hidden Markov Model of at least a portion of the sequential data stream i;
(c) selecting a sequential data stream j from the plurality of sequential data streams;
(d) designing a Hidden Markov Model of at least a portion of the sequential data stream j;
(e) computing a quantitative measure of similarity between the sequential data stream and the sequential data stream j using the Hidden Markov Model of the at least a portion of the sequential data stream i and the Hidden Markov Model of the at least a portion of the sequential data stream j; and
(f) repeating steps (c), (d), and (e) for each sequential data stream j in the plurality of sequential data streams, thereby computing a vector of quantitative measures of similarity for the sequential data stream i.

11. The method according to claim 10, further comprising:
repeating steps (a), (b), (c), (d), (e), and (f) for each sequential data stream i in the plurality of sequential data streams, thereby computing a matrix of quantitative measures of similarity;
normalizing the matrix of quantitative measures of similarity into a probability matrix of probabilities p(j|i); and
performing an Eigen analysis on the probability matrix, thereby defining a multi-dimensional eigenspace.

12. The method according to claim 11, further comprising plotting at least some of the plurality of sequential data streams in a graphical representation of at least two dimensions of the multi-dimensional eigenspace.

13. The method according to claim 12, further comprising plotting at least some of the plurality of sequential data streams in a graphical representation of at least three dimensions of the multi-dimensional eigenspace.

14. The method according to claim 12, further comprising:
selecting a sequential data stream from the plurality of sequential data streams; and
sorting two or more unselected sequential data streams according to distances between the two or more unselected sequential data streams and the selected sequential data stream, wherein the distances are calculated in the multi-dimensional eigenspace.

15. The method according to claim 10, further comprising sorting two or more of the sequential data streams j according to quantitative measures of similarity between the two or more of the sequential data streams j and the sequential data stream i.

16. A system for quantifying and representing similarities between sequential data streams, the system comprising:
a modeling processor configured to design a first Hidden Markov Model of at least a portion of a first member of a pair of sequential data streams and a second Hidden Markov Model of at least a portion of a second member of a pair of sequential data streams; and
a comparison processor configured to compute a quantitative measure of similarity between the first and second members of the pair of sequential data streams using the first Hidden Markov Model and the second Hidden Markov Model.

17. The system according to claim 16, further comprising:
a plurality of sequential data streams; and
a vector composition processor configured to compose a vector of quantitative measures of similarity for a sequential data stream selected from the plurality of sequential data streams, the vector being composed of quantitative measures of similarity computed by the comparison processor between the selected sequential data stream and each unselected sequential data stream.

18. The system according to claim 17, further comprising a storage medium upon which the plurality of sequential data streams are stored.

19. The system according to claim 17, further comprising a matrix composition processor configured to compose a matrix of quantitative measures of similarity for the plurality of sequential data streams, the matrix being composed of vectors of quantitative measures of similarity computed by the vector composition processor for each sequential data stream.

20. The system according to claim 19, further comprising an Eigen analysis processor configured to perform an Eigen analysis on the matrix of quantitative measures of similarity, thereby defining a multi-dimensional eigenspace.

21. The system according to claim 20, further comprising a sorting processor configured to sort two or more of the plurality of sequential data streams according to distances between each of the two or more of the plurality of sequential data streams and a sequential data stream of interest, the distances being calculated in the multi-dimensional eigenspace.

22. The system according to claim 20, further comprising:
a plotting processor configured to output a graphical representation of at least some of the plurality of sequential data streams in at least two dimensions of the multi-dimensional eigenspace; and
an output device configured to display the graphical representation.

23. The system according to claim 22, further comprising controls configured to manipulate the graphical representation.

24. The system according to claim 17, wherein the vector of quantitative measures of similarity is expressed in terms of random walk probabilities.

25. The system according to claim 17, further comprising a sorting processor configured to sort two or more of the plurality of sequential data streams according to quantitative measures of similarity between each of the two or more of the plurality of audio streams and the selected sequential data stream.

26. A system for searching a plurality of data streams, the system comprising:
a selection interface configured to present a plurality of data streams and to accept a user's selection of one or more data streams therefrom;
a vector composition processor configured to define a quantitative measure of similarity vector for each of the selected one or more data streams;
a search interface configured to define a quantitative measure of similarity search criterion; and
a search processor configured to identify one or more unselected data streams meeting the defined quantitative measure of similarity criterion using the quantitative measure of similarity vector for each of the selected one or more data streams.

27. The system according to claim 26, wherein the vector composition processor comprises:
a modeling processor configured to design a Hidden Markov Model of at least a portion of each of the plurality of data streams;
a similarity processor configured to use the designed Hidden Markov Models to compute a plurality of quantitative measures of similarity between the selected one or more data streams and each unselected data stream; and
a composition processor configured to compose a vector of the plurality of quantitative measures of similarity computed for each of the selected one or more data streams.

28. The system according to claim 26, wherein each of its processors is configured to process a plurality of audio streams.

29. The system according to claim 28, further comprising an output device configured to present the identified one or more unselected data streams meeting the defined quantitative measure of similarity criterion.
